(19) United States
(12) Patent Application Publication
(10) Pub. No.: US 2023/0418099 A1
(43) Pub. Date: Dec. 28, 2023

(54) IMPROVED TRANSPARENCY OF POLYMER WALLED DEVICES AND METHODS OF MAKING THE SAME

(71) Applicant: NITTO DENKO CORPORATION, Ibaraki-shi, Osaka (JP)

(72) Inventors: Piotr POPOV, San Diego, CA (US); Neil CRAMER, Boulder, CO (US)

(21) Appl. No.: 18/037,910

(22) PCT Filed: Nov. 17, 2021
(86) PCT No.: PCT/US2021/059673

§ 371 Date: May 19, 2023

Related U.S. Application Data
(60) Provisional application No. 63/115,968, filed on Nov. 19, 2020.

(51) Int. Cl. G02F 1/1333; G02F 1/137; G02F 1/1334

(52) U.S. Cl. CPC G02F 1/133377; G02F 1/13756; G02F 1/13347; G02F 1/13775

(57) ABSTRACT

A liquid crystal based switchable light modulating device comprising polymer wall structure with improved transparency is disclosed.

### CROSS-REFERENCE TO RELATED APPLICATIONS

This application claims the benefit of U.S. Provisional Application No. 63/115,968, filed Nov. 19, 2020, which is incorporated by reference herein in its entirety.

### BACKGROUND

In the fenestration industry, smart windows are attractive alternatives to conventional mechanical shutters, blinds, or hydraulic methods of shading. Efforts have been made to optimize smart windows to control the amount of light, e.g. ultraviolet, visible, and infrared light, passing through windows. Such control may be to provide privacy, reduce heat from ambient sunlight, and control harmful effects of ultraviolet light.

Liquid crystals or other kind of functional liquid phase materials may be used for light modulation in response to various external stimuli, such as thermal stimulus, UV light stimulus, electric field stimulus, magnetic field stimulus and so on. Polymer dispersed liquid crystal (PDLC) technology has been utilized to contain liquid crystals as droplets within a polymer matrix. However, PDLC technology has poor optical performance and such devices require relatively high driving voltage.

Responsive to these needs, approaches having compartmentalized liquid crystal layers have been described. However, these may not satisfy the optical clarity requirements for display and/or smart window applications. In addition, these may not be utilizable in roll-to-roll fabrication processes because of high speed manufacturing requirements.

Therefore, there is a need for light modulating devices that may address any or all of the shortcomings mentioned above, having high quality polymer wall constructs formed in a controlled process compatible with high throughput manufacturing requirements. Such a device may have better transparency in one of its states, improved viewing angles, lower driving voltage and lower power consumption (for example, capable of being powered by battery).

### SUMMARY

Light modulating devices, and methods for their preparation, are described herein. The light modulating devices of the present disclosure comprise a light modulating layer disposed between, and in contact with, a first transparent electrically conductive element and a second transparent electrically conductive element; wherein the light modulating layer comprises compartments defined by polymer walls bonded respectively to and between the first transparent electrically conductive element and the second transparent electrically conductive element; wherein the compartments comprise a liquid crystal material; and wherein the polymer walls have a refractive index that is within ±0.5 of the refractive index of the first transparent electrically conductive element and the refractive index of the second transparent electrically conductive element.

The light modulating device may further comprise a voltage source in electrical communication with the transparent electrodes.

The polymer walls and the compartments of the light modulating layer may be prepared by a method comprising forming the polymer walls and the compartments defined by the polymer walls by exposing a precursor polymer matrix comprising a reactive monomer(s) and a liquid crystal material to ultraviolet light, wherein a patterned photomask placed upon the device during the exposure to ultraviolet light causes a patterned polymerization of the reactive monomer(s) to form the polymer walls and the compartments.

In some embodiments, the reactive monomer may be an acrylate monomer. In some embodiments, the acrylic monomer may be a methacrylate monomer or an ethyl acrylate monomer. In some embodiments, the ethyl acrylate monomer may be 2-phenoxyethyl acrylate. In some examples, the liquid crystal material may be a nematic liquid crystal material or a cholesteric liquid crystal material or a smectic liquid crystal. In some embodiments, the precursor polymer matrix may further comprise a chiral dopant, a polymerization inhibitor, a UV-blocker, a photoinitiator, microsphere spacer beads, or a combination thereof.

The precursor polymer matrix and the polymer walls of the light modulating layer may comprise multiple polymers in order to tune or modify the refractive index of the polymer wall to closely match the refractive index of the substrates of the electrically conductive elements. Some embodiments include a method for tuning or modifying the refractive index of polymer walls. The method comprises selecting an acrylic analogue as the main reactive monomer. In some embodiments, the acrylic analogue may be 2-phenoxyethyl acrylate. In some embodiments, the method may comprise adding a refractive index reducing monomer, wherein the refractive index reducing monomer has a refractive index less than the refractive index of the main reactive monomer. In some embodiments, the method may comprise adding a refractive index increasing monomer, wherein the refractive index increasing monomer has a refractive index greater than the refractive index of the main reactive monomer. The method may further comprise adjusting the relative amounts of main reactive monomer, refractive index decreasing monomer and/or the refractive index increasing monomer. In some embodiments, the refractive index reducing monomer comprises hexyl acrylate. In some embodiments, the refractive index increasing monomer comprises ethoxylated o-phenyl phenol acrylate (A-LEN-10).

In some embodiments, the undesired haze of the transparent state of the device may be 10% or less when a voltage source is applied.

These and other embodiments are described in greater detail below.

### BRIEF DESCRIPTION OF THE DRAWINGS

FIG. 1 is a schematic cross section of a light modulating device incorporating the polymer wall structure described herein.

FIG. 2 is a schematic used for calculation of polymer wall width L that may be invisible to human eye at close viewing distance.

FIG. 3 is a POM microscopy image of polymer walls composed of an embodiment polymer formula (EX-F0).

FIG. 4 is a POM microscopy image of polymer walls composed of an embodiment polymer formula (EX-F10).

FIG. 5 is a POM microscopy image of a polymerized PEA-based embodiment (EX-F11) formulation without liquid crystal.

FIG. 6 is a POM microscopy image of polymer walls of a butyl acrylate embodiment (EX-F1) to compartmentalize a nematic liquid crystal.

FIG. 7 is a POM microscopy image of polymer walls of a benzyl acrylate embodiment (EX-F2) to compartmentalize a nematic liquid crystal.

FIG. 8 is a POM microscopy image of a EGDA crosslinked monomer polymer wall embodiment (EX-F3) to compartmentalize a nematic liquid crystal.

FIG. 9 is a POM microscopy image of a PEA reactive monomer polymer wall embodiment (EX-F4) to compartmentalize a nematic liquid crystal.

FIG. 10A is a POM microscopy image showing a PEA reactive monomer polymer wall embodiment (EX-F0) to compartmentalize a nematic liquid crystal. A non-photomasked area and a rectangular PDLC area chosen for magnification is shown.

FIG. 10B is a magnification of the rectangular area indicated in FIG. 10A.

FIG. 11A is a POM microscopy image showing an A-LEN-10 reactive monomer polymer wall embodiment (EX-F5) to compartmentalize a nematic liquid crystal. A non-photomasked area and a rectangular PDLC area chosen for magnification is shown.

FIG. 11B is a magnification of the rectangular area indicated in FIG. 11A.

FIG. 12 is a POM microscopy image of polymer walls composed of A-LEN-10 reactive monomer to compartmentalize a nematic liquid crystal (embodiment (EX-F5).

FIG. 13 is a POM microscopy image of polymer walls composed of PEA and A-LEN-10 reactive monomers to compartmentalize a nematic liquid crystal (EX-F6).

FIG. 14A is a POM microscopy image of polymer walls composed of PEA and A-LEN-10 reactive monomers to compartmentalize a cholesteric liquid crystal (EX-F7). A rectangular area chosen for magnification is shown.

FIG. 14B is a magnification of the rectangular area indicated in FIG. 14A. A rectangular area chosen for magnification is shown.

FIG. 14C is a magnification of the rectangular area indicated in FIG. 14B.

FIG. 15 is a POM microscopy image of polymer walls composed of PEA and A-LEN-10 reactive monomers to compartmentalize a cholesteric liquid crystal (EX-F7), shown in the transparent (clear) state.

FIG. 16 is a POM microscopy image of polymer walls composed of PEA and A-LEN-10 reactive monomers to compartmentalize a cholesteric liquid crystal (EX-F7), shown in the light scattering (darkened) state.

FIG. 17 is a POM microscopy image of polymer walls composed of PEA and HA reactive monomers to compartmentalize a cholesteric liquid crystal (EX-F8), shown in the transparent (clear) state.

FIG. 18 is a POM microscopy image of polymer walls composed of PEA and HA reactive monomers to compartmentalize a cholesteric liquid crystal (EX-F8), shown in the light scattering (darkened) state.

FIG. 19 is a POM microscopy image of polymer walls composed of PEA and HA reactive monomers to compartmentalize a cholesteric liquid crystal (EX-F9), shown in the transparent (clear) state.

FIG. 20 is a POM microscopy image of polymer walls composed of PEA and HA reactive monomers to compartmentalize a cholesteric liquid crystal (EX-F9), shown in the light scattering (darkened) state.

### DETAILED DESCRIPTION

The present disclosure relates to light modulating devices comprising polymer walls that have improved transparency when switched to a clear state by applying an electric field. These light modulating devices may be useful in fenestration applications for increased energy efficiency and privacy. A method for making such light modulating devices is also described.

The term “transparent” or “clear” as used herein, means that the structures do not absorb a significant amount of visible light radiation or reflect a significant amount of visible light radiation, rather, it is transparent to visible light radiation.

The term “polymer matrix,” as used herein includes a composite mixture of at least one polymer and at least one liquid crystal compound. The polymer matrix may further comprise solvents, reactive diluents, polymerization inhibitors, UV-blockers, photoinitiators, microsphere spacer beads, crosslinkers and other polymerized monomers, or any combination thereof.

The term “monofunctional,” as used herein, includes compounds with one radically polymerizable group.

The term “multi-functional,” as used herein, includes compounds, e.g., (meth)acrylates, with two (“difunctional”) or more (“polyfunctional”), preferably 2 to 4, radically polymerizable groups.

The term “linear polymer,” as used herein, includes a macromolecule made of monomeric units arranged in a long and/or unbranched chain.

The term “crosslinked polymer,” as used herein, includes a macromolecule that has covalent bonds between the monomeric units from the separate linear polymer chains.

The term “main reactive monomer” includes the primary monomer utilized in constructing the polymer wall structure of the light modulating layer.

The term “refractive index reducing monomer” includes a monomer that has a refractive index of a lower numerical value than the main reactive monomer.

The term “refractive index increasing monomer” includes a monomer that has a refractive index of a greater numerical value than the main reactive monomer.

Use of the term “may” or “may be” should be construed as shorthand for “is” or “is not” or, alternatively, “does” or “does not” or “will” or “will not,” etc. For example, the statement “the liquid crystal composition may comprise a photoinitiator” should be interpreted as, for example, “In some embodiments, the liquid crystal composition comprises a photoinitiator or does not comprise a photoinitiator,” or “In some embodiments, the liquid crystal composition will comprise a photoinitiator or will not comprise a photoinitiator,” etc.

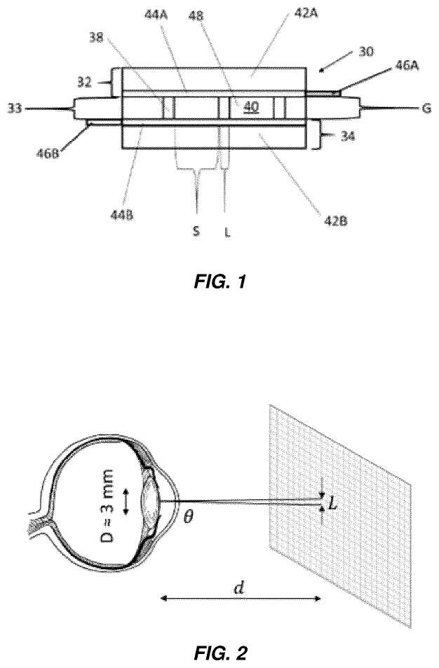

FIG. 1 depicts an embodiment of a light modulating device, such as device 30. The light modulating device may comprise a first transparent electrically conductive element, such as element 32; a second transparent electrically conductive element, such as element 34; and a light modulating layer, such as layer 33, disposed between and in contact with the first transparent electrically conductive element and the second transparent electrically conductive element (see FIG. 1).

In some embodiments, the first transparent electrically conductive element may be a first transparent electrically conductive substrate. In some embodiments, the second transparent electrically conductive element may be a second transparent electrically conductive substrate. In some embodiments, the transparent electrically conductive elements, e.g., the first transparent electrically conductive element and/or the second transparent electrically conductive element, may be hydroxy activated.

Referring again to FIG. 1, In some embodiments, the light modulating layer may comprise a liquid crystal compound (not shown). In some embodiments, the light modulating layer may comprise a plurality of polymer wall constructs, such as constructs 38, bonded to, and positioned between, the first electrically conductive element and the second transparent electrically conductive element. In some embodiments, the first transparent electrically conductive element may comprise a substrate, such as substrate 42A, and the second transparent electrically conductive element may comprise as substrate, such as substrate 42B. In some embodiments, the first transparent electrically conductive element may comprise an electrically conductive layer, such as layer 44A, and the second transparent electrically conductive element may comprise an electrically conductive layer, such as layer 44B. In some embodiments, the substrates may comprise non-conductive materials. In some embodiments, the width of the polymer wall may have a dimension, such as dimension L. In some examples, the dimension of the compartment defined by the polymer walls may have a dimension, such as dimension S. A cell gap, such as gap G, may space apart the first and second transparent electrically conductive elements. In some examples, electrical leads, such as leads 46A and 46B, may be attached to the first electrically conductive layer and the second electrically conductive layer, respectively. In some embodiments, the polymer wall constructs may define compartments (which may also be called cavities or reservoirs), such as compartments 40, therebetween. The polymer wall constructs may be formed from suitable polymer monomers (vide infra). In some embodiments, the light modulating layer may comprise a liquid crystal composition, a chiral dopant, ultraviolet (UV) blockers, polymerization inhibitors, photo-initiators, or a combination thereof. In some embodiments, a light modulating composition, such as composition 48, e.g., a mixture of reactive monomers, liquid crystal compositions and other additives, may be disposed within the defined compartments. An external voltage source (not shown) may be connected to the electrical leads to switch the light modulating device from an opaque state to a transparent state. The voltage source may be an AC voltage source. The voltage source may be an AC-DC inverter and a battery. In some embodiments, the voltage source may be a DC battery, such as thin cell.

In some embodiments, the light modulating device may comprise a first substantially transparent element and a second substantially transparent element. In some embodiments, the first and second substantially transparent elements may comprise a first and second electrically conductive substrate, respectively. In some embodiments, the first and second electrically conductive substrates may comprise materials having a first refractive index and a second refractive index, respectively. In some embodiments, the first electrically conductive substrate and the second transparent electrically conductive substrate may have a refractive index within ±0.5 of the main reactive monomer refractive index and/or the liquid crystal material refractive index. In some embodiments, the substrates may comprise a non-conductive material. The substrate is not particularly limiting, and with the benefit of this disclosure, one skilled in the art of light modulating devices would be able to determine an appropriate material for the substantially transparent substrates. Some non-limiting examples of transparent substrates include glass and polymer films. Typical polymer films include films made of polyolefin, polyester, polyethylene terephthalate (PET), polyvinyl chloride, polyvinyl fluoride, polyvinylidene difluoride, polyvinyl butyral, polyacrylate, polycarbonate, polyurethane, etc., or a combination thereof. In some embodiments, the polymer film may have a refractive index closely matched with the main reactive monomer and/or the liquid crystal material. In some embodiments, the polymer film may have a refractive index within ±0.5 of the main reactive monomer refractive index and/or the liquid crystal material refractive index. In some embodiments, the polymer film of the first and/or second substrate may comprise PET. PET substrates have an ordinary refractive index of about 1.575.

In some embodiments, the substrates may comprise a first transparent electrode and a second, opposing transparent electrode. The first and second electrodes may comprise an indium tin oxide (ITO), a fluorine doped tin oxide (FTO), a poly(3,4-ethylenedioxythiophene) polystyrene sulfonate (PEDOT:PSS), a silver oxide, a zinc oxide, or any suitable transparent conductive polymer or film coating. In some embodiments, the opposing electrodes may have an inside facing conductive surface and an outward/distal facing exterior surface. In some embodiments, the electrically conductive layers may be further coated with thin transparent insulating (electrically not conducting) layers. In some embodiments, the non-conducting materials may be selected from Al₂O₃, SiOₓ, or Ni₃O₅. Chemical vacuum deposition, chemical vapor deposition, evaporation, sputtering or other suitable coating techniques may be used for applying conducting and non-conducting layers on substrate. The purpose of coating non-conducting layer over the conducting layer is to reduce the likelihood of electrical shorting of the light shutter device upon bending or through undesired electrically conducting particulate contamination within the LC or polymer phase between the opposing substrates.

In some embodiments, where there is an electron conduction layer present, the substrate may comprise a non-conductive material. In some embodiments, non-conductive material may comprise glass, polycarbonate, polymer, or combinations thereof. In some embodiments, the substrate polymer may comprise polyvinyl alcohol (PVA), polycarbonate (PC), acrylics including but not limited to poly(methyl methacrylate) (PMMA), polystyrene, allyl diglycol carbonate (e.g. CR-39), polyesters, polyetherimide (PEI) (e.g. Ultem®), Cyclo Olefin polymers (e.g. Zeonex®), triacetylcellulose (TAC), polyethylene terephthalate (PET), polyethylene naphthalate (PEN), or combinations thereof. In some embodiments, the substrate may comprise polyethylene terephthalate (PET), polyethylene naphthalate (PEN), or a combination thereof. In some embodiments, the electron conduction layer may comprise a transparent conductive oxide, a conductive polymer, metal grids, carbon nanotubes (CNT), graphene, or a combination thereof. In some embodiments, the transparent conductive oxide may comprise a metal oxide. In some embodiments, the metal oxide may comprise iridium tin oxide (IrTO), indium tin oxide (ITO), fluorine doped tin oxide (FTO), doped zinc oxide, or a combination thereof. In some embodiments, the metal oxide may comprise indium tin oxide incorporated onto the base, e.g. ITO glass, ITO PET, or ITO PEN.

In some embodiments, the transparent element may comprise a first substrate, e.g., a first transparent electrode, and a second substrate, e.g., a second transparent electrode. In some embodiments the transparent element may comprise a light modulating layer. In some embodiments, the light modulating layer may comprise a liquid crystal compound, and a plurality of polymer walls. In some embodiments the light modulating layer may comprise a liquid crystal compound, a chiral dopant, ultraviolet (UV) blockers, polymerization inhibitors, photoinitiators, or a combination thereof. In some embodiments, the plurality of polymer wall constructs may be bonded to and between the first substrate and the second substrate, and the polymer walls may define plural compartments therebetween. In some embodiments, the polymer wall constructs may comprise at least a monofunctional and/or additional multi-functional reactive monomer units and/or subunits. In some embodiments, the plural compartments may comprise a liquid crystal composition disposed therein, for example by an in-situ phase separation of polymer and liquid crystal during curing. In some embodiments, the polymer walls may have a refractive index that is closely matched with the refractive index of the transparent substrates and/or of the liquid crystal compound. In some examples, the refractive index of the transparent substrates may be within about ±1.0, about 0.5, about 0.1, about +0.05, or about ±0.025 of the refractive index of the transparent substrates and/or of the liquid crystal compound. Suitable, but non-limiting reactive monomer compounds, that may polymerize to form the polymer wall construct, are shown in Table 1, below.

In some embodiments, the polymer walls may comprise a main reactive polymer. In some embodiments, the main reactive monomer may have a refractive index between about 1.3 to about 1.8, about 1.3-1.4, about 1.4-1.5, about 1.5-1.6, about 1.6-1.7, about 1.7-1.8, about 1.4-1.6, or any value in a range bounded by any of these values. In some embodiments, the main reactive polymer may comprise an alkyl acrylate analogue. In some embodiments, the acrylate analogue may comprise a methacrylate, a methacrylate analog, an ethyl acrylate analogue, or a combination thereof. In some embodiments, the ethyl acrylate analogue may comprise 2-phenoxyethyl acrylate (PEA). In some embodiments, the polymer wall construct monomer precursor may comprise a refractive index reducing monomer. A refractive index reducing monomer, as used herein, includes a monomer that has a lower refractive index than the main reactive monomer in the polymer precursor formulation. In some embodiments, the refractive index reducing monomer may be an alkyl acrylate analogue. In some examples, the refractive index reducing monomer may be hexyl acrylate (HA), butyl acrylate, or benzyl acrylate. In some embodiments, the polymer walls may comprise a refractive index increasing monomer. A refractive index increasing monomer, as used herein, includes a monomer that has a higher refractive index than the main reactive monomer in the polymer precursor formulation. In some embodiments, where the main reactive monomer may be an alkyl acrylate analogue. In some examples, the refractive index increasing monomer may be an alkoxylated aryl acrylate. In some embodiments, the refractive index increasing monomer may be ethoxylated o-phenyl phenol acrylate, e.g., A-LEN-10 monomer (Shin-Nakamura Chemicals, Osaka, Japan). In some embodiments, the polymer walls may comprise at least one main reactive monomer, a refractive index reducing monomer, a refractive index increasing monomer, or a combination thereof.

In some embodiments, the polymer walls may be formed from a pre-cured polymer matrix formulation. In some embodiments, the pre-cured formulation may comprise the main reactive monomer in a wt % of about 0.05 wt % to about 50 wt %, about 0.05-1 wt %, about 1-5 wt %, about 5-10 wt %, about 10-15 wt %, about 15-20 wt %, about 20-25 wt %, about 25-50 wt %, about 50-75 wt %, about 75-100 wt % or about 12 wt %, about 12.5 wt %, about 15.0 wt %, about 20 wt %, about 24 wt %, about 25 wt %, 100 wt %, or any wt % in a range bounded by any of these values, based upon the total weight of the reactive monomers.

In some embodiments, the pre-cured formulation may comprise PEA in a wt % of about 0.05 wt % to about 50 wt %, about 0.05-1 wt %, about 1-5 wt %, about 5-10 wt %, about 10-15 wt %, about 15-20 wt %, about 20-25 wt %, about 25-50 wt %, about 50-75 wt %, about 75-100 wt % or about 12 wt %, about 12.5 wt %, about 15.0 wt %, about 20 wt %, about 24 wt %, about 25 wt %, 100 wt %, or any wt % in a range bounded by any of these values, based upon the total weight of the reactive monomers.

In some embodiments, the pre-cured formulation may comprise butyl acrylate in a wt % of about 0.05 wt % to about 50 wt %, about 0.05-1 wt %, about 1-5 wt %, about 5-10 wt %, about 10-15 wt %, about 15-20 wt %, about 20-25 wt %, about 25-50 wt %, about 50-75 wt %, about 75-100 wt % or about 12 wt %, about 12.5 wt %, about 15.0 wt %, about 20 wt %, about 24 wt %, about 25 wt %, 100 wt %, or any wt % in a range bounded by any of these values, based upon the total weight of the reactive monomers.

In some embodiments, the pre-cured formulation may comprise benzyl acrylate in a wt % of about 0.05 wt % to about 50 wt %, about 0.05-1 wt %, about 1-5 wt %, about 5-10 wt %, about 10-15 wt %, about 15-20 wt %, about 20-25 wt %, about 25-50 wt %, about 50-75 wt %, about 75-100 wt % or about 12 wt %, about 12.5 wt %, about 15.0 wt %, about 20 wt %, about 24 wt %, about 25 wt %, 100 wt %, or any wt % in a range bounded by any of these values, based upon the total weight of the reactive monomers.

In some embodiments, wherein the main reactive monomer is PEA, the pre-cured polymer matrix formulation may comprise a refractive index reducing monomer. In some embodiments, wherein the main reactive monomer is PEA, the refractive index reducing monomer may be hexyl acrylate. In some embodiments, the pre-cured formulation may comprise the reactive index reducing monomer in an amount of about 1 wt % to about 20 wt %, about 1-5 wt %, about 5-10 wt %, about 10-15 wt %, about 15-20 wt %, about 20-30 wt %, or about 5 wt %, about 10 wt %, about 12 wt %, about 12.5 wt %, about 15 wt %, about 20 wt %, about 24 wt %, about 25 wt %, or any wt % in a range bounded by any of these values.

In some embodiments, the pre-cured formulation may comprise hexyl acrylate in an amount of about 1 wt % to about 20 wt %, about 1-5 wt %, about 5-10 wt %, about 10-15 wt %, about 15-20 wt %, about 20-30 wt %, or about 5 wt %, about 10 wt %, about 12 wt %, about 12.5 wt %, about 15 wt %, about 20 wt %, about 24 wt %, about 25 wt %, or any wt % in a range bounded by any of these values.

In some embodiments, wherein the main reactive monomer is PEA, the pre-cured polymer matrix formulation may comprise a refractive index increasing monomer. In some embodiments, such as when the main reactive monomer may be PEA, the refractive index increasing monomer may be ethoxylated o-phenyl phenol acrylate (e.g., A-LEN-10, monomer). In some embodiments, the amount of refractive index increasing monomer in the pre-cured formulation may comprise about 1 wt % to about 50 wt %, about 1-5 wt %, about 5-10 wt %, about 10-15 wt %, about 15-20 wt %, about 20-25 wt %, about 25-30 wt %, about 30-35 wt %, about 35-40 wt %, about 40-45 wt %, about 45-50 wt %, or about 12.5 wt %, about 13 wt %, about 25 wt % or any wt % in a range bounded by any of these values.

In some embodiments, the amount of ethoxylated o-phenyl phenol acrylate in the pre-cured formulation may be about 1 wt % to about 50 wt %, about 1-5 wt %, about 5-10 wt %, about 10-15 wt %, about 15-20 wt %, about 20-25 wt %, about 25-30 wt %, about 30-35 wt %, about 35-40 wt %, about 40-45 wt %, about 45-50 wt %, or about 12.5 wt %, about 13 wt %, about 25 wt % or any wt % in a range bounded by any of these values.

In some embodiments, the polymers walls may comprise suitable relative amounts of the above described materials to reduce the differences of the refractive indices of the polymer walls, the transparent substrates and/or the liquid crystal.

In some embodiments, suitable reactive monomers having different refractive indices are described in Table 1. In some embodiments, the reactive monomers may have only an alkyl chain, only one aromatic or non-aromatic ring, two or more conjugated rings, and/or combinations of these internal molecular structures. In some embodiments, the reactive monomers used in formulations may be monofunctional, or multi-functional, or monofunctional and multi-functional monomers mixed together.

In some embodiments, the multi-functional monomeric unit may be partially polymerized with a crosslinking monomer unit to provide crosslinking within the polymer walls. In some embodiments, the crosslinking monomer may comprise a difunctional or multi-functional monomer, e.g., diacrylate, triacrylate or another polyacrylate monomer. In some embodiments, the crosslinking monomer unit may comprise hexane-1,6-dithiol (HDT), tricyclodecanedimethanol diacrylate (TCDDA), 1,6-hexanediol diacrylate (HDDA), hydroxyl pivalic acid neopentyl glycol diacrylate (HPNDA, M210), trimethylolpropane triacrylate (TMPTA), ethylene glycol diacrylate (EDDA), diethylene glycol diacrylate (DEGDA), diethylene glycol dimethacrylate (DEGDMA), triethylene glycol diacrylate (TEGDA), diethylene glycol dimethacrylate, triethylene glycol diacrylate, triethylene glycol dimethacrylate, trimethylol propane, diallyl ether, trimethylolpropane triacrylate, pentaerythritol triacrylate, pentaerithritol tetracrylate, pentaerythol pentacrylate, dipentaerythrytol hydroxy pentacrylate or combinations thereof. In some embodiments, the multi-functional monomer unit may be selected from hexane-1,6-dithiol (HDT), Ethylene glycol diacrylate (EGDA), hexane-1,6-diyldiacrylate (HDDA), Dipropylene glycol diacrylate (DPGDA), Tricyclodecane dimethanol diacrylate (TCDDA), Tris[2-(acryloyloxy)ethyl] isocyanurate (TATATO), and/or Pentaerythritol tetrakis(3-mercaptopropionate) (PETMP).

TABLE 1

| | | | Refractive | |
|---|---|---|---|---|
| | | M.W. | index | |
| Name | CAS: | [g/mol] | [n20/D] | Structure |
| Methyl acrylate | 96-33-3 | 86.09 | 1.402 | 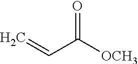 |
| Ethyl acrylate | 140-88-5 | 100.12 | 1.406 | 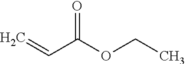 |
| Butyl acrylate | 141-32-2 | 128.17 | 1.418 | 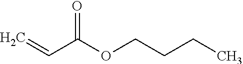 |
| Hexyl acrylate | 2499-95-8 | 156.22 | 1.428 | 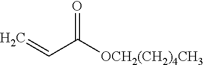 |
| Octyl acrylate | 2499-59-4 | 184.28 | 1.437 | 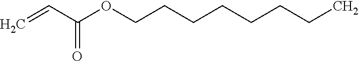 |
| 2-Ethylhexyl acrylate | 103-11-7 | 184.28 | 1.436 | 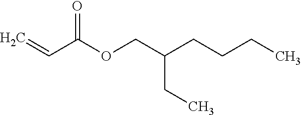 |
| Phenyl acrylate | 937-41-7 | 148.2 | 1.521 | 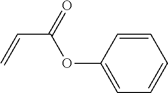 |
| Benzyl acrylate | 2495-35-4 | 162.19 | 1.514 | 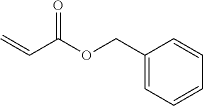 |
| 2-Phenoxyethyl acrylate (PEA) | 48145-04-6 | 192.2 | 1.518 | 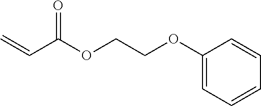 |
| Ethoxylated o- phenyl phenol acrylate (A- LEN-10) | 72009-86-0 | 268.0 | 1.577 | 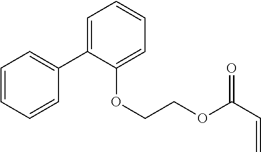 [SMILES: C=CC(=O)OCCOc1ccccc1-c1ccccc1] |
| 1-Naphthyl methacrylate | 19102-44-4 | 212.24 | 1.588 | 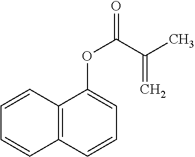 [SMILES: C=C(C)C(=O)Oc1cccc2ccccc12] |
| 1,4-Phenylene diacrylate | 6729-79-9 | 218 | 1.531 | 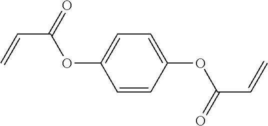 [SMILES: C=CC(=O)Oc1ccc(OC(=O)C=C)cc1] |
| Ethylene glycol diacrylate (EGDA) | 2274-11-5 | 170.2 | 1.453 | 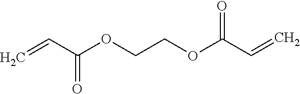 |
| Hydroxy pivalic acid neopentyl glycol diacrylate (HPNDA, M210) | 30145-51-8 | 312 | 1.452 | 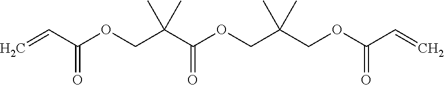 [SMILES: C=CC(=O)OCC(C)(C)COC(=O)C(C)(C)COC(=O)C=C] |

In some embodiments, the viscosity of the pre-curing formulation components may be less than 200 (mPa·s at 25° C.). In some embodiments, the main reactive polymer may have a pre-cured viscosity of less than 50 (mPa·s at 25° C.), e.g., PEA has a viscosity of 9 (mPa·s at 25° C.). In some embodiments, the modified refractive index polymer may have a viscosity of less than 200 (mPa·s at 25° C.), e.g., A-LEN-10 has a viscosity of 150 (mPa·s at 25° C.). It is believed that the lower the viscosity of the material, the higher the diffusion of the pre-cured polymer matrix facilitating more rapid separation of the polymer wall material from the liquid crystal material, enabling the polymer walls to form in a shorter amount of time.

In some embodiments, the refractive index of cured polymer walls may be greater after polymerization relative to the refractive index of the reactive monomers. The refractive index change of commercial acrylic polymer precursor materials may have an average gain of refractive index, after polymerization, of about +1.79% (Aloui et al., “Refractive index evolution of various commercial acrylic resins during photopolymerization”, eXPRESS Polymer Letters Vol. 12, No. 11 (2018) 966-971). This refractive index gain increase may be used in estimating the refractive index of the cured polymer walls in the examples described herein. It is believed that this increase in refractive index may be accounted for, and adjusted when formulating a reactive monomer mixture. By adding additional reactive monomers, the refractive index of the polymer wall constructs may be modulated to more closely match the refractive index of liquid crystal and/or the refractive index of transparent substrates.

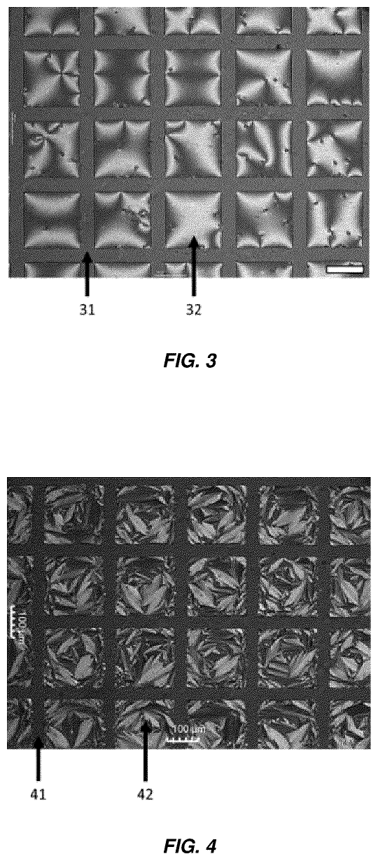

In some embodiments, the light modulating layer may comprise a liquid crystal compound. In some embodiments, the polymer wall constructs may define compartments therebetween. In some embodiments, the liquid crystal compound may be disposed within the polymer wall defined compartments. In some embodiments, the liquid crystal compound may comprise a nematic liquid crystal compound. Any suitable nematic liquid crystal compound may be used. In some embodiments, the liquid crystal compound with positive dielectric anisotropy may be QYPDLC-8 (Qingdao QY Liquid Crystal Co. Ltd.), which has an ordinary refractive index of 1.526. In some embodiments, polymer walls may encapsulate a nematic liquid crystal. As shown in FIG. 3, PEA-based polymer walls, such as walls 31, define compartments, such as compartments 32, containing a nematic liquid crystal material. In some embodiments, polymer walls may encapsulate a cholesteric liquid crystal. As shown in FIG. 4, PEA-based polymer walls, such as walls 41, define compartments, such as compartments 42, containing a cholesteric liquid crystal material. In some embodiments, other types of liquid crystals or non-liquid crystalline materials may be encapsulated using the same methods described in this disclosure.

In some embodiments, the polymer matrix may further comprise a chiral dopant, a polymerization inhibitor, a UV-blocker, a photoinitiator, microsphere spacer beads, or a combination thereof.

In some embodiments, the liquid crystal compound may comprise a nematic liquid crystal material. In some embodiments, the nematic liquid crystal material may be QYPDLC-8. In some embodiments, the polymer matrix may comprise an optional chiral dopant. A “chiral dopant” is a compound having a function of arranging a liquid crystal material (for example, a nematic liquid crystal material) so that it has a chiral structure. Any suitable chiral dopant may be selected, such as R811, S811, R1011, S1011, R5011, or S5011 (Merck KGaA, Darmstadt, Germany). In some embodiments, the chiral dopant may be about 0.1 wt % to about 10.0 wt %, about 0.1-1.0 wt %, about 1-2 wt %, about 2-3 wt %, about 3-4 wt %, about 4-5 wt %, about 5-6 wt %, about 6-7 wt %, about 7-8 wt %, about 8-9 wt %, about 9-10 wt %, or about 3 wt %, or about 6 wt % of the polymer matrix, or any value in a range bounded by any of these values.

In some embodiments, the polymer matrix of the light modulating device may comprise a polymerization inhibitor agent that may delay reactive monomer polymerization. In some embodiments, the reaction inhibitor may be phenothiazine, N-nitroso-N-phenylhydroxylamine aluminum salt, or a mixture thereof. It is believed that upon UV irradiation of the reactive monomer containing formulation, the photo-initiator molecules may break down into radicals. These radicals initiate the polymerization of reactive monomers, but only after the inhibitor molecules are substantially consumed. Typically, formulations may contain dissolved oxygen, which may act as a reaction inhibitor. Therefore, a conversion delay may be typically observed. An alternative description could be that, due to the establishment of a concentration gradient, there may be a higher concentration of the inhibitor at the interface between the exposed curing radiation position and the non-exposed radiation position. Inhibitor concentration could be above a threshold minimizing polymerization/conversion at the boundary and conversion/polymerization proceeds at the center or median position in the exposed radiation area, where the concentration is lower due to being consumed. This phenomenon may be made even more pronounced by adding additional inhibitor compounds and/or agents. It is believed that this procedure contributes to the double-sided additive polymerization formation of the polymer wall from the center of the exposed radiation area outwards towards the boundary of the exposed and un-exposed photomasked areas. In some embodiments, suitable inhibitor additives may be PTZ (phenothiazine, CAS: 92-84-2), Q-1301 (N-nitrosophenylhydroxylamine aluminum salt, CAS: 15305-07-4), HQ (hydroquinone, CAS: 123-31-9), TBC (tert-butyl catechol, CAS: 98-29-3), MEHQ (Me-hydroquinone or 4-methoxyphenol, CAS: 150-76-5), or a combination thereof. In some embodiments, the formulation may comprise PTZ. In some embodiments, the PTZ inhibitor concentration may be increased to provide polymer wall growth from the middle of the polymer wall location to the edges of the liquid crystal compartments. It is believed that PTZ is suitable because it has a relatively lower molecular weight, e.g., less than 250 g/μmol, and therefore may have a higher molecular mobility. In some embodiments, the polymerization inhibitor agent additive may be about 0.01 wt % to about 5.0 wt %, about 0.01-0.1 wt %, about 0.1-0.5 wt %, about 0.5-1 wt %, about 1-2 wt %, about 2-3 wt %, about 3-4 wt %, about 4-5 wt %, or about 0.1 wt %, about 1 wt % of the precursor polymer matrix, or any value in a range bounded by any of these values.

In some embodiments, the polymer matrix of the light modulating device may comprise a UV-blocker agent. In some embodiments, the UV-blocker agent may be a UV-absorber such as OB+(2,5-bis(5-tert-butyl-benzoxazol-2-yl)thiophene, CAS: 7128-64-5), UV-790, or a combination thereof. It is believed that the morphology of polymerizing polymer wall is relatively rough, due to Raleigh-Taylor instabilities, enabling scattering of the polymerizing radiation outside of the desired or intended area of exposure. It is believed that Incorporation of a UV blocker agent reduces the polymerizing or converting effects of the UV radiation outside of the desired (un-photomasked) area. In some embodiments, the UV-blocker agent additive may be about 0.01 wt % to about 5.0 wt %, about 0.01-0.1 wt %, about 0.1-0.5 wt %, about 0.5-1.0 wt %, about 1-2 wt %, about 2-3 wt %, about 3-4 wt %, about 4-5 wt %, or about 0.5 wt % of the precursor mixture, or any value in a range bounded by any of these values.

In some embodiments, the liquid crystal composition may comprise a photoinitiator. In some embodiments, the photoinitiator may comprise a UV irradiation photoinitiator. In some embodiments, the photoinitiator may also comprise a co-initiator. In some embodiments, the photoinitiator may comprise an α-alkoxydeoxybenzoin, α,α-dialkyloxydeoxybenzoin, α,α-dialkoxyacetophenone, α,α-hydroxyalkylphenone, O-acyl α-oximinoketone, dibenzoyl disulphide, S-phenyl thiobenzoate, acylphosphine oxide, dibenzoylmethane, phenylazo-4-diphenylsulphone, 4-morpholino-α-dialkylaminoacetophenone, or a combination thereof. In some embodiments, the photoinitiator may comprise Irgacure® 184, Irgacure® 369, Irgacure® 500, Igracure® 651, Igracure® 907, Irgacure® 1117, Irgacure® 1700, 4,4′-bis(N,N-dimethylamino)benzophenone (Michlers ketone), (1-hydroxycyclohexyl) phenyl ketone, 2,2-diethoxyacetophenone (DEAP), benzoin, benzyl, benzophenone, or a combination thereof. In some embodiments, the photoinitiator may comprise a blue-green and/or red sensitive photoinitiator. In some embodiments, the blue-green and/or red photoinitiator may comprise Irgacure® 784, dye rose bengal ester, rose bengal sodium salt, campharphinone, methylene blue, and the like. In some embodiments, co-initiators may comprise N-phenylglicine, triethylamine, thiethanolamine or a combination thereof. It is believed that co-initiators may control the curing rate of the original pre-polymer such that material properties may be manipulated. In some embodiments, the photoinitiator may comprise an ionic photoinitator. In some embodiments, the ionic photoinitiator may comprise a benzophenone, camphorquinone, fluorenone, xanthone, thioxanthone, benzyls, α-ketocoumarin, anthraquinone, terephthalophenone, or a combination thereof. In some embodiments, the photoinitiator is a Type I photoinitiator. In some embodiments, the photoinitiator may comprise diphenyl (2,4,6-trimethylbenzoyl)phosphine oxide (TPO-L, Ciba Specialty Chemicals, Inc., Basel, Switzerland). In some embodiments, the photoinitiator additive may be about 0.01 wt % to about 5.0 wt %, about 0.01-0.1 wt %, about 0.1-0.5 wt %, about 0.5-1.0 wt %, about 1-2 wt %, about 2-3 wt %, about 3-4 wt %, about 4-5 wt %, or about 0.5 wt %, or any value in a range bounded by any of these values, of the precursor polymer matrix.

In some embodiments, the liquid crystal composition may comprise microsphere spacer beads. In some embodiments, the microsphere spacer beads may comprise Nanomicro HT100 spacer beads. In some examples, the spacer beads may be about 5-20 μm, about 5-6 μm, about 6-7 μm, about 7-8 μm, about 8-9 μm, about 9-10 μm, about 10-11 μm, about 11-12 μm, about 12-13 μm, about 13-14 μm, about 14-15 μm, about 15-16 μm, about 16-17 μm, about 17-18 μm, about 18-19 μm, about 19-20 μm, about 8-12 μm, about 10 μm, or any size in a range bounded by any of these values. In some embodiments, the microsphere spacer beads may be present in about 0.01 wt % to about 5.0 wt %, about 0.01-0.05 wt %, about 0.05-0.1 wt %, about 0.1-0.5 wt %, about 0.5-1 wt %, about 1-2 wt %, about 2-3 wt %, about 3-4 wt %, about 4-5 wt %, about 0.01 wt %, about 0.05 wt %, about 0.1 wt %, about 0.5 wt %, about 1 wt %, or any wt % in a range bounded by any of these values, of the precursor polymer matrix.

In some embodiments the photomask used for polymer wall formation by UV curing has repeating pattern of squares having side S=200 μm and separated from each other by transparent lines L=30 μm.

In some embodiments, the photomask used for polymer wall formation by UV curing may have a repeating pattern of squares having side S=100 μm and separated from each other by transparent lines L=15 μm. By reducing photomask feature dimensions by factor of 2 it is possible to shorten the curing time by factor of 4, because the diffusion time of reactive monomers depends quadratically on the diffusion distance. Therefore, device fabrication time may be significantly reduced, for example from 20 minutes to 5 minutes. At the same time, the peel strength may be maintained at the same level because although the polymer walls are two times thinner, they repeat two times more frequently.

In some embodiments, the transparent photomask line width may be chosen based on optical considerations to provide resulting polymer walls having width small enough to ensure said polymer walls are invisible to human vision even at close viewing distance. FIG. 2 shows a geometric schematic used for calculation of polymer wall thickness L. The resolution of human eye is limited by diffraction limit expressed by Raleigh criterion as 0≈1.22 λ/D where θ is angular resolution, λ is wavelength of light, e.g. 550 nm, and D is pupil diameter at day light. Therefore θ≈2.2·10⁻⁴ rad. The smallest resolvable feature at viewing distance d, e.g. at typical close viewing distance d=25 cm is therefore: L=2·d·tan θ/2, thus L≈55 μm. At a very close viewing distance, e.g. d=10 cm to 15 cm, the polymer walls to be invisible, L must be no more than 30 μm, or more preferably no more than 20 μm.

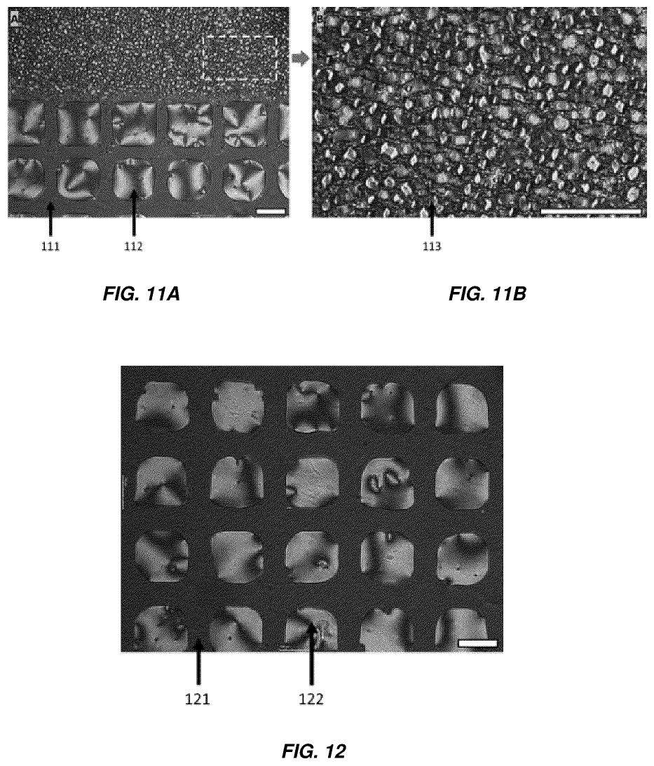

In some embodiments a light modulating device may be made without using a photomask and instead forming a PDLC structure having low polymer content. In some embodiments the liquid crystal droplet size in the PDLC structure may be controlled by choosing a reactive monomer or by mixing different reactive monomers. FIG. 10 shows a magnification of PDLC region where PEA-based device was non-photomasked during UV exposure. The liquid crystal phase separates from cured PEA by forming very small droplets, such as droplets 103, having characteristic size of about ˜1 μm. FIG. 11 shows a magnification of PDLC region where an A-LEN-10-based device was non-photomasked during UV exposure. The liquid crystal phase separates from cured A-LEN-10 by forming very large droplets, such as droplets 113, having a characteristic size of about 10 to 20 μm. The scale bars in FIG. 10 and FIG. 11 represent 100 μm.

Some embodiments include a method of tuning or modifying the refractive index of polymer walls. The method may comprise selecting a main reactive monomer having a refractive index within 0.5 of the refractive index of the transparent conductive substrate and/or the liquid crystal composition. In some embodiments, the method may comprise selecting a main reactive monomer having refractive index between 1.3 and 1.8 before curing. In some embodiments, the method may comprise adding a refractive index reducing monomer, wherein the refractive index reducing monomer has a refractive index less than the refractive index of the main reactive monomer. In some embodiments, the method may comprise adding a refractive index increasing monomer, wherein the refractive index increasing monomer has a refractive index greater than the refractive index of the main reactive monomer. In some embodiments, the method may comprise adjusting the relative amounts of main reactive monomer(s), refractive index decreasing monomer(s) and/or refractive index increasing monomer(s) to attain a refractive index polymer wall in the range from 1.3 to 1.8 and/or within ±0.5 of the refractive index of the transparent conductive substrate refractive index and/or the liquid crystal compound refractive index.

Hereinafter, representative embodiments and methods will be described in more detail.

### Embodiments

Embodiment 1. A light modulating device comprising:
a first and a second transparent electrically conductive substrates having transparent electrically conductive substrates refractive indices;
a light modulating layer, said light modulating layer comprising a liquid crystal compound, and a plurality of polymer walls; and
a plurality of polymer walls bonded respectively to and between the first and second transparent electrically conductive substrates; such that said polymer walls have a tunable refractive index within ±0.5 of the refractive indices of transparent electrically conductive substrates and/or of the liquid crystal compound.

Embodiment 2. The light modulating device of embodiment 1, wherein the polymer walls comprise an acrylate analogue.

Embodiment 3. The light modulating device of embodiment 2, wherein the acrylate analogue comprises a methacrylate or ethylacrylate analogue.

Embodiment 4. The light modulating device of claim 2, wherein the acrylate analogue comprises 2-phenoxyethyl acrylate (PEA), hexyl acrylate, ethoxylated o-phenyl phenol acrylate monomers and/or mixtures thereof.

Embodiment 5. The light modulating device of embodiment 1, wherein the polymer wall further comprises a chiral dopant, a polymerization inhibitor, a UV-blocker, a photoinitiator, or any combination thereof.

Embodiment 6. The light modulating device of embodiment 1, wherein sufficient polymerization inhibitor is present to reduce the presence of trapped liquid crystal within the polymer walls is less than 1% of cured polymer wall content, or the polymerization inhibitor comprises 0.01 wt % to 5 wt % of the formulation.

Embodiment 7. A light modulating device of embodiment 1, wherein polymer walls are formed by UV exposure through a photomask and wherein said device exhibits improved transparency when electric field is applied to said device (normal mode) or when electric field is turned off (reverse mode).

Embodiment 8. A method of tuning refractive index of polymer walls:
selecting a main reactive monomer having refractive index between 1.3 and 1.8 before curing;
adding a refractive index reducing monomer, wherein the refractive index reducing monomer has a refractive index less than the refractive index of the main reactive monomer;
adding a refractive index increasing monomer, wherein the refractive index increasing monomer has a refractive index greater than the refractive index of the main reactive monomer;
adjusting the ratios of main reactive monomer(s), refractive index decreasing monomer(s) and/or refractive index increasing monomer(s) to attain a refractive index polymer wall in the range from 1.3 to 1.8.

Embodiment 9. The method of embodiment 8, wherein the main reactive monomer comprises 2-phenoxyethyl acrylate.

Embodiment 10. The method of embodiment 6, wherein the refractive index reducing monomer comprises hexyl acrylate.

Embodiment 11. The method of embodiment 6, wherein the refractive index increasing monomer comprises ethoxylated o-phenyl phenol acrylate (A-LEN-10).

Embodiment 12. The method of embodiment 6, further adjusting the ratios of reactive monomers having different refractive indices to account for increased refractive index due to increased density of cured polymer walls.

Embodiment 13. A light modulating device comprising:
a first and a second transparent electrically conductive substrates;
a light modulating layer, said light modulating layer comprising a polymer matrix, said polymer matrix comprising a PEA monomer, an index of refraction modifying monomer, and a liquid crystal compound.

Embodiment 14. The light modulating device of embodiment 13, further comprising a chiral dopant, a polymerization inhibitor, a UV-blocker, a photoinitiator, a PDLC type polymer matrix, or any combination thereof.

### Examples

It has been discovered that embodiments of the liquid crystal light modulating device, polymer wall system, etc. described herein have improved optical performance as compared to other forms of light modulating devices. These benefits are further demonstrated by the following examples, which are intended to be illustrative of the disclosure only but are not intended to limit the scope or underlying principles in any way.

Creation of Polymerizable Liquid Crystal Syrups:

For EX-F0, a mixture of 75 wt % of nematic liquid crystal material QYPDLC-8 (Qingdao QY Liquid Crystal Co. Ltd.), 25 wt % 2-phenoxyethyl acrylate (PEA) (Millipore Sigma, St. Louis, MO, USA). These first components with optional second reactive monomer for refractive index tuning, optional crosslinker and optional chiral dopant S1011 add up to 100 wt % and make the base formulation. Then 1 wt % PTZ (phenothiazine, Millipore Sigma, St. Louis, MO, USA), 0.5 wt % UV-790 (QIDONG JINMEI CHEMICAL CO, LTD), and 0.5 wt % photo-initiator diphenyl (2,4,6-trimethylbenzoyl)phosphine oxide (TPO-L, Ciba Specialty Chemicals, Inc., Basel, Switzerland), and 1 wt % of 10 μm spacers (NM HT-100) were mixed in a 10 ml glass vial. The syrup was then heated to above the clearing point of the liquid crystal, e.g. to 100° C., and mixed using a vortex mixer to form a homogeneous mixture.

The process was repeated for the additional mixtures synthesized with the exception that the mass ratios of the constituents were varied as shown in Table 2.

TABLE 2

| | Base Formulation | | | | | Additives | | |
|---|---|---|---|---|---|---|---|---|
| | PEA (RM 1) | RM 2 | Cross-linker | QYPDLC-8 | S1011 | PTZ | UV-790 | TPO-L |
| Example | [wt %] | [wt %] | [wt %] | [wt %] | [wt %] | [wt %] | [wt %] | [wt %] |
| EX-F0 | 25 | 0 | 0 | 75 | 0 | 1 | 0.5 | 0.5 |
| EX-F1 | 0 | Butyl | 0 | 75 | 0 | 1 | 0.5 | 0.5 |
| | | Acrylate | | | | | | |
| | | 25 wt % | | | | | | |
| EX-F2 | 0 | Benzyl | 0 | 75 | 0 | 1 | 0.5 | 0.5 |
| | | Acrylate | | | | | | |
| | | 25 wt % | | | | | | |
| EX-F3 | 0 | 0 | EGDA | 75 | 0 | 1 | 0.5 | 0.5 |
| | | | 25 wt % | | | | | |
| EX-F4 | 24 | 0 | HPNDA | 75 | 0 | 1 | 0.5 | 0.5 |
| | | | 1 wt % | | | | | |
| EX-F5 | 0 | A-LEN-10 | 0 | 75 | 0 | 1 | 0.5 | 0.5 |
| | | 25 wt % | | | | | | |
| EX-F6 | 12 | A-LEN-10 | 0 | 75 | 0 | 1 | 0.5 | 0.5 |
| | | 13 wt % | | | | | | |
| EX-F7 | 12.5 | A-LEN-10 | 0 | 69 | 6 | 1 | 0.5 | 0.5 |
| | | 12.5 wt % | | | | | | |
| EX-F8 | 15 | Hexyl | 0 | 72 | 3 | 1 | 0.5 | 0.5 |
| | | Acrylate | | | | | | |
| | | 10 wt % | | | | | | |
| EX-F9 | 20 | Hexyl | 0 | 72 | 3 | 1 | 0.5 | 0.5 |
| | | Acrylate | | | | | | |
| | | 5 wt % | | | | | | |
| EX-F10 | 25 | 0 | 0 | 69 | 6 | 0.1 | 0.5 | 0.5 |
| EX-F11 | 100 | 0 | 0 | 0 | 0 | 1 | 0.5 | 0.5 |

After mixing the aforementioned precursor formulations, an additional 1 wt % of the 10 μm microsphere spacer beads (Nanomicro HT100) are added.

Fabrication of Light Modulating Device:

3″ long, 1.5″ wide PET-ITO flexible substrate (Elecrysta C100-02RJC5B, Nitto Denko, Osaka, JP) were rinsed with acetone, blow-dried with compressed air. A droplet of a sample prepared as described above, e.g., formulation EX-F0, is then deposited on the surface of the conducting layer of the first substrate. The second substrate is placed on top of the droplet in contact with its conducting layer surface, a roller is then applied to spread the formulation between the substrates. A photomask may be placed atop the coated flexible substrate. The photomask used had L=30 μm and S=200 μm. Excess formulation extruding from the edges is removed, then the fabricated item is placed under a UV LED lamp (395 nm) for 15 minutes at an intensity of 0.5 mW/cm² at room temperature.

Afterwards, both substrates of the light modulating device with polymer walls can be electrically connected by soldering wires to the ITO terminals such that each conductive substrate is in electrical communication with a voltage source, where the communication is such that when the voltage source is applied an electric field will be generated across the device. The voltage source will provide the necessary voltage across the device to enable the reorientation of the liquid crystal molecules.

Characterization by Polarizing Microscopy:

The optical characteristics of the flexible device prototypes were characterized by observing constructed samples on a polarizing optical microscope (POM) (AmScope PZ200 TB Polarizing Trinocular microscope; United Scope LLC dba AmScope, Irvine CA, USA). Images of samples were recorded by equipping the POM with a camera (AmScope Digital Camera MU130 1.3 MP). The sample being assessed was placed on the POM stage. The polarizers were turned in a crossed configuration. An objective lens (for example, 4×, 10×, 40×) was chosen for a desired level of magnification, e.g., about 2500×'s. Live observations were made on a computer screen using the digital camera. Position of the objective lens and microscope stage was adjusted until the image on the screen was in sharp focus. Photos and videos were captured using the bundled AmScope 3.7 software running on Microsoft Windows 10 operating system. All scale bars in captured photographs represent 100 μm.

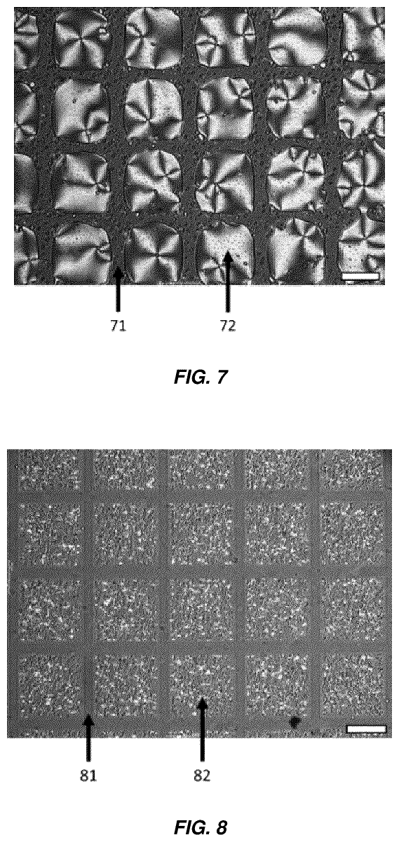

Assessing the light allowed to pass through each fabricated light modulating element, see FIGS. 3, 4, 5, 6, 7, 8, 9, 10, 11, 12, 13, 14, 15, 16, 17, 18, 19, and 20 for representative microscopy image of a device. The polarizers were crossed in each microscopy image. The length of the respective scale bars represents 100 μm. FIGS. 6 and 7 exhibit trapped liquid crystal microdroplets within the polymer wall constructs 61 and 71, respectfully, as shown by the dot like structures within the walls. At least FIGS. 3, 4, 5, 6, 7, 8, 9, 10, 11, 12, 13, 14, 15, 16, 17, 18, 19, 20 exhibit polymer wall constructs 31, 41, 51, 61, 71, 81, 91, 101, 111, 121, 131, 141, 151, 161, 171, 181, 191, 201, and liquid crystal rich compartments 32, 42, 52, 62, 72, 82, 92, 102, 112, 122, 132, 142, 152, 162, 172, 182, 192, 202, accordingly. FIGS. 3, 4, 12, 13, 14, 15, 16, 17, 18, 19, 20 exhibited an absence of trapped liquid crystal droplets within the polymer walls 31, 41, 121, 131, 141, 151, 161, 171, 181, 191, 201, accordingly. FIGS. 3, 4, 12, 13, 14, 15, 16, 17, 18, 19, 20 also exhibited an absence of polymer aggregates within the liquid crystal rich compartments 32, 42, 122, 132, 142, 152, 162, 172, 182, 192, 202, accordingly. FIG. 10B showed that non-photomasked area produces small LC droplets if PEA reactive monomer was used. FIG. 11B showed that non-photomasked area produced large LC droplets if A-LEN-10 reactive monomer was used.

As shown in FIG. 3, polymer walls 31 made only with PEA reactive monomer are very well defined and well phase separated from nematic liquid crystal 32 contained in each square compartment.

As shown in FIG. 4, polymer walls 41 made only with PEA reactive monomer are very well defined and well phase separated from cholesteric liquid crystal 42 contained in each square compartment.

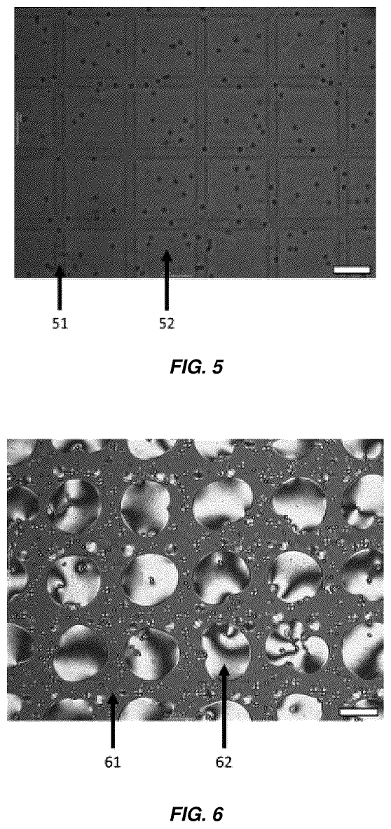

FIG. 5 demonstrates cured (solid) PEA-based polymer walls compartmentalizing uncured (liquid) PEA-based formulation EX-F11 (See Table 2) having no liquid crystals. It is believed the polymer walls were visible in FIG. 5 because cured solid (higher density) PEA has an increased refractive index compared to uncured liquid PEA monomer. The scale bar in FIG. 5 represents 100 μm.

As shown in FIG. 14, POM microscopy of Sample EX-F7, made as described above, at progressively increasing magnification showed that cholesteric liquid crystal 142 was only present in their compartments and no cholesteric LC was present in trapped droplets within the polymer walls 141. Transparency of polymer walled devices was believed to be higher when no undesired liquid crystal trapped droplets were observed within the polymer walls. The scale bars in FIG. 14 represent 100 μm.

FIG. 6 (EX-F1) represents a POM microscopy image of attempting to form polymer walls 61 using butyl acrylate monomer instead of PEA. Separation of liquid crystal rich phase 62 occurred, but the polymer walls were not as well defined as the PEA walls (shown in FIG. 3 or FIG. 4).

FIG. 7 (EX-F2) represents a POM microscopy image of polymer walls 71 using benzyl acrylate monomer instead of PEA. Separation of liquid crystal rich phase 72 occurred, but clearly curing conditions may be adjusted to achieve well defined polymer walls as shown in FIG. 3.

FIG. 8 (EX-F3) represents a POM microscopy image of forming polymer walls 81 using a crosslinker monomer without any monofunctional reactive monomers. Liquid crystal 82 phase separate partially under these same curing conditions. This figure suggests that a crosslinker such as EGDA may be used alone without other reactive monomers. It is believed that diacrylates gelate at low conversion levels and curing intensity may need to be decreased and exposure time increased to allow more complete phase separation of polymer walls from liquid crystals.

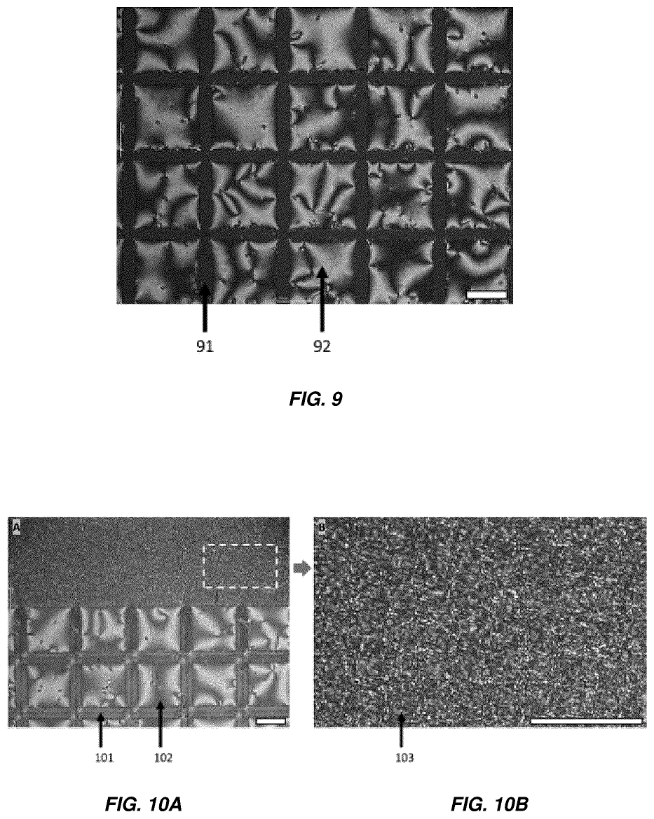

FIG. 9 (EX-F4) shows example POM microscopy image of forming polymer walls 91 made mostly with PEA monofunctional monomer and small amount of crosslinker HPNDA to increase mechanical modulus of said polymer walls. Liquid crystal 92 was fairly well phase separated and was well encapsulated in this example as the process was optimized for the PEA monomer that is in majority.

FIG. 10A is a POM microscopy image showing PEA reactive polymer walls embodiment (EX-F0) to compartmentalize a nematic liquid crystal material. A photomasked area produced the polymer walls structures. A non-photomasked area produced PDLC structure having droplets with sizes on the order of 1 μm. FIG. 10B is a magnification of the rectangular PDLC area indicated in FIG. 10A. Polarizers were crossed; scale bars represent 100 μm.

FIG. 11 is a POM microscopy image showing A-LEN-10 reactive monomer polymer walled embodiment (EX-F5) to compartmentalize a nematic liquid crystal material. A photomasked area produced polymer walls structures. A non-photomasked area produced PDLC structure having droplets with sizes on the order of 10-20 μm. FIG. 11B is a magnification of a rectangular PDLC area indicated in FIG. 11A.

FIG. 12 (EX-F5) shows example POM microscopy image of forming polymer walls 121 made only with a high refractive index monofunctional monomer A-LEN-10. Liquid crystal rich compartments 122 appeared to have rounded corners suggesting that interfacial tension between liquid crystal rich phase and the forming A-LEN-10 based polymer wall was higher than PEA based polymer wall. It is suggested that additional appropriate small molecular weight surfactant could be used to help better define the square geometry of the liquid crystal rich compartments.

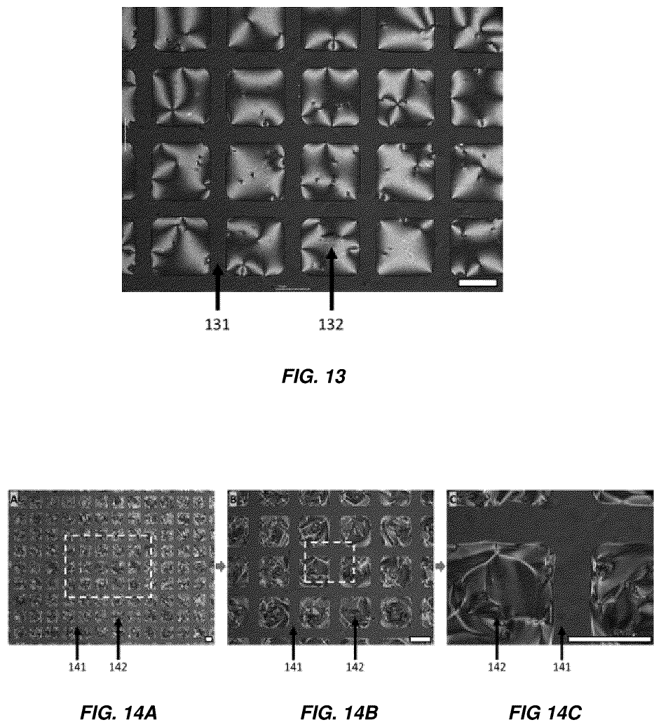

FIG. 13 (EX-F6) shows example POM microscopy image of forming polymer walls 131 made with PEA and A-LEN-10 reactive monomers approximately at 1:1 ratio. Liquid crystal rich compartments 132 appeared to have only slightly rounded corners in this case indicating that phase separation has occurred to a high degree.

FIG. 14A (EX-F7) depicts a POM microscopy image of a PEA at 12.5 wt % and A-LEN-10 at 12.5 wt % reactive monomers polymer wall embodiment to compartmentalize cholesteric liquid crystal. FIG. 14B and FIG. 14C show the same device at different magnifications (as indicated by the scale bars, all representing 100 μm). Polarizers are crossed; scale bars represent 100 μm.

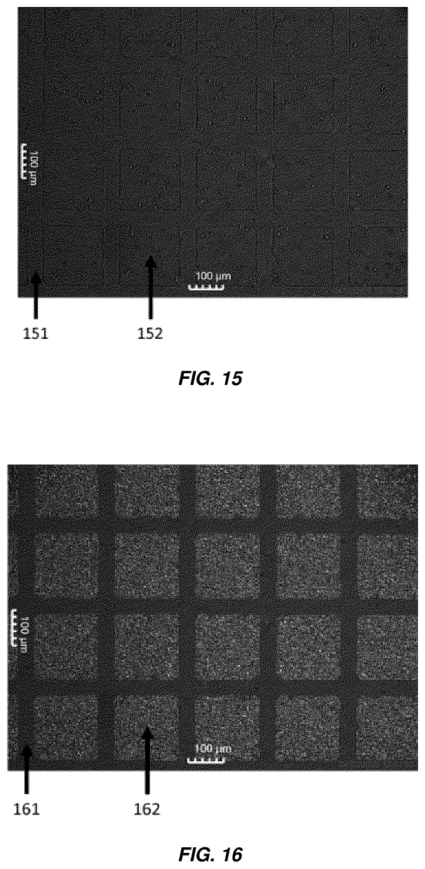

FIG. 15 (EX-F7) shows an example of POM microscopy image of polymer walls 151 made with PEA and A-LEN-10 at 1:1 ratio that are phase separated from cholesteric liquid crystal 152. The A-LEN-10 monomer was added to increase the refractive index of the pure PEA reactive monomer. In this example 2 V/μm at 60 Hz was applied to align liquid crystals homeotropically. The transparency of the device made with this formulation (EX-F7) was higher than transparency of a similar device that is made only with lower refractive index PEA monomer formulation such as (EX-F0). In this example the estimated refractive index of cured polymer walls from formulation (EX-F7) was about 1.575, which matches the 1.575 refractive index of PET substrates, but was higher than the ordinary refractive index of the liquid crystal which was 1.526.

As shown in FIG. 16 (EX-F7), after removing the voltage the liquid crystals 162 return to a focal conic configuration and scatter light.

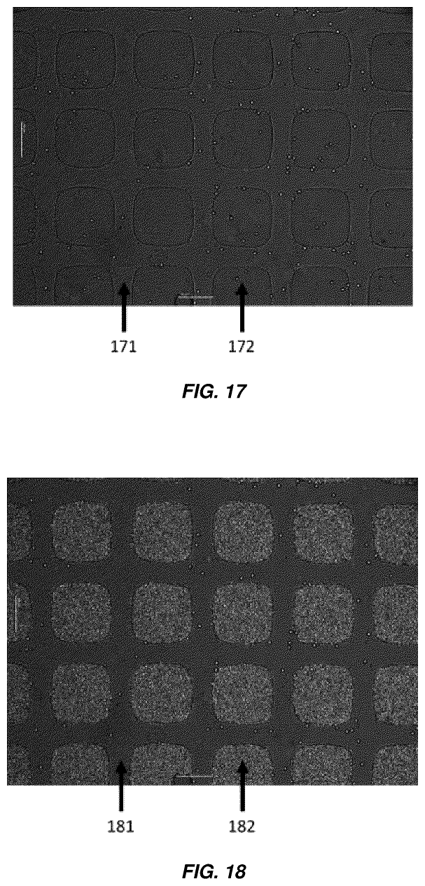

FIG. 17 (EX-F8). shows an example of POM microscopy image of polymer walls 171 made with PEA and hexyl acrylate at 3:2 ratio that were phase separated from cholesteric liquid crystal 172. The purpose of the hexyl acrylate monomer was to decrease the refractive index of the pure PEA reactive monomer. In this example 2 V/μm at 60 Hz was applied to align liquid crystals homeotropically. The transparency of the device made with this formulation (EX-F8) was noticeably lower than transparency of a similar device that is made with lower refractive index PEA monomer formulation such as (EX-F7).

As shown in FIG. 18 (EX-F8), after removing the voltage the liquid crystals 182 returned to a focal conic configuration and scatter light.

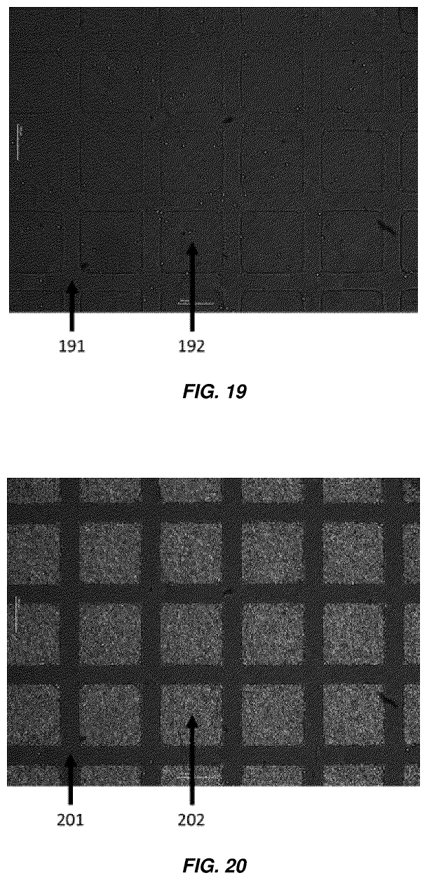

FIG. 19 (EX-F9) shows an example of POM microscopy image of polymer walls 191 made with PEA and hexyl acrylate at 4:1 ratio that were phase separated from cholesteric liquid crystal 192. In this example 2 V/μm at 60 Hz was applied to align liquid crystals homeotropically. The transparency of the device made with this formulation (EX-F9) was still lower than transparency of a similar device that was made with only PEA-based monomer formulation such as (EX-F0) but was slightly higher than in the case of the device made with the example formulation (EX-F8). In this example the estimated refractive index of cured polymer walls from formulation (EX-F9) was about 1.526, which matches the 1.526 ordinary refractive index of the liquid crystal but is lower than the ordinary refractive index of the PET substrates which is 1.575.

As shown in FIG. 20 (EX-F9), after removing the voltage the liquid crystals 202 return to a focal conic configuration and scatter light.

TABLE 2

| Device Description | Haze @ 40 V, 60 Hz |
|---|---|
| No optimization (EX-F10) | 13.72% |
| Trapped LC droplets removed (EX-F0) | 6.74% |
| Trapped LC droplets removed and | 3.05% |
| refractive index adjusted (EX-F7) | |

As shown in Table 2, the undesired haze in transparent states of the devices may be significantly reduced. By increasing the content of PTZ inhibitor from 0.1 wt % in EX-F10 to 1 wt % in EX-F0 the undesired haze was decreased from ˜13.72% to ˜6.74%.

As shown in Table 2, the undesired haze may be further decreased by adding a refractive index increasing monomer A-LEN-10 to the main monomer PEA. The undesired haze in transparent state of the devices was improved from ˜6.74% to ˜3.05%.

The undesired haze may be reduced even further by subtracting the light scattered on spacer beads used to hold the 10 μm cell gap between the pair of substrates. The undesired haze arising from light scattered on spacer beads at 1 wt % in LC/polymer precursor formulation accounts for about 1-2%.

Examples of devices made with formulations EX-F7 and EX-F9 suggest that higher device transparency may be achieved by matching refractive index of polymer walls to refractive index of the substrates, rather than to ordinary refractive index of the liquid crystal. It is still preferable, if possible, to match refractive indices of all device elements such as of cured polymer walls, of substrates, of liquid crystal and/or of spacers.

The examples described above demonstrate that refractive index of polymer walls may be adjusted by the disclosed methods. Following the discoveries made here it is possible to improve the transparency of the polymer walled liquid crystal-based devices.

While the present disclosure has been shown and described in connection with the embodiments, it will be apparent to those skilled in the art that modifications and variations may be made without departing from the spirit and scope of the present disclosure as defined by the appended embodiments.

The terms “a”, “an”, “the” and similar referents used in the context of describing the present disclosure (especially in the context of the following claims) are to be construed to cover both the singular and the plural, unless otherwise indicated herein or clearly contradicted by context. All method described herein may be performed in any suitable order unless otherwise indicated herein or contradicted by context. The use of any and all examples or representative language (e.g., “such as”) provided herein is intended merely to better illuminate the present disclosure and does not pose a limitation on the scope of any claim. No language in the specification should be construed as indicating any non-claimed element essential to the practice of the present disclosure.

Groupings of alternative elements or embodiments disclosed herein are not to be construed as limitations. Each group member may be referred to and claimed individually or in any combination with other members of the group or other elements found herein. It is anticipated that one or more members of a group may be included in, or deleted from, a group for reasons of convenience.

Certain embodiments are described herein, including the best mode known to the inventors for carrying out the present disclosure. Of course, variations on these described embodiments, will become apparent to those or ordinary skill in the art upon reading the foregoing description. The inventor expects skilled artisans to employ such variations as appropriate, and the inventors intend for the disclosure to be practiced otherwise than specifically described herein. Accordingly, the claims include all modifications and equivalents, or the subject matter recited in the claims as permitted by applicable law. Moreover, any combination of the above described elements in all possible variations thereof is contemplated unless otherwise indicated herein or otherwise clearly contradicted by context.

In closing, it is to be understood that the embodiments disclosed herein are illustrative of the principles of the claims. Thus, by way of example, but not limitation, alternative embodiments may be utilized in accordance with the teachings herein. Accordingly, the claims are not limited to embodiments precisely as shown or described.

1. A light modulating device comprising:
a light modulating layer disposed between, and in contact with, a first transparent electrically conductive element and a second transparent electrically conductive element;
wherein the light modulating layer comprises compartments defined by polymer walls bonded respectively to and between the first transparent electrically conductive element and the second transparent electrically conductive element;
wherein the compartments comprise a liquid crystal material; and
wherein the polymer walls have a refractive index that is within ±0.5 of the refractive index of the first transparent electrically conductive element and the refractive index of the second transparent electrically conductive element.

2. The light modulating device of claim 1, wherein the liquid crystal material is a nematic liquid crystal compound or a cholesteric liquid crystal material.

3. The light modulating device of claim 1, wherein the polymer walls are formed from a precursor polymer matrix comprising an acrylate monomer and a liquid crystal material, wherein the acrylate monomer comprises a methacrylate monomer, an ethyl acrylate monomer, or a combination thereof.

4. The light modulating device of claim 3, wherein the acrylate monomer comprises 2-phenoxyethyl acrylate, hexyl acrylate, ethoxylated o-phenyl phenol acrylate, or a combination thereof.

5. The light modulating device of claim 1, wherein the first transparent electrically conductive element comprises a first transparent substrate having a first transparent electrode, and the second transparent electrically conductive element comprises a second transparent substrate having a second transparent electrode.

6. The light modulating device of claim 1, wherein the first transparent electrically conductive element and the second transparent electrically conductive element comprise a polyethylene terephthalate substrate and an indium tin oxide electrode.

7. The light modulating device of claim 5, wherein the first transparent electrode and the second transparent electrode are in contact with the light modulating layer.

8. The light modulating device of claim 5, further comprising a voltage source in electrical communication with the first transparent electrode and the second transparent electrode, such that when the voltage source is applied an electrical field is generated across the device.

9. The light modulating device of claim 8, wherein the device exhibits improved transparency when the voltage source is applied, providing a haze of 10% or less.

10. A method for making the light modulating layer of claim 1, comprising forming the polymer walls and the compartments defined by the polymer walls by exposing a precursor polymer matrix comprising a reactive monomer and a liquid crystal material to ultraviolet light, wherein a patterned photomask placed upon the device during the exposure to ultraviolet light causes a patterned polymerization of the reactive monomer to form the polymer walls and the compartments.

11. The method of claim 10, wherein the precursor polymer matrix further comprises a chiral dopant, a polymerization inhibitor, a UV-blocker, a photoinitiator, microsphere spacer beads, or a combination thereof.

12. The method of claim 11, wherein the precursor polymer matrix comprises about 6 wt % or less of the chiral dopant.

13. The method of claim 11, wherein the precursor polymer matrix comprises 0.01 wt % to 5 wt % of the polymerization inhibitor.

14. The method of claim 11, wherein the precursor polymer matrix comprises about 0.01 wt % to about 5 wt % of the UV-blocker.

15. The method of claim 11, wherein the precursor polymer matrix comprises about 0.01 wt % to about 5 wt % of the photoinitiator.

16. The method of claim 11, wherein the precursor polymer matrix comprise about 0.01 wt % to about 5 wt % of the microsphere spacer beads.

17. The method of claim 10, wherein the refractive index of the polymer walls are tuned by adjusting the relative amounts of acrylate polymers in the precursor polymer matrix comprising:
combining a main reactive monomer having a refractive index between 1.3 and 1.8 with a refractive index reducing monomer, a refractive index increasing monomer, or a combination thereof;
wherein the refractive index reducing monomer has a refractive index less than the refractive index of the main reactive monomer and the refractive index increasing monomer has a refractive index greater than the refractive index of the main reactive monomer; and
adjusting the relative amounts of the main reactive monomer, the refractive index reducing monomer, or the refractive index increasing monomer to attain a polymer wall having a refractive index between about 1.3 and about 1.8.

18. The method of claim 17, wherein the main reactive monomer comprises 2-phenoxyethyl acrylate.

19. The method of claim 17, wherein the refractive index reducing monomer comprises hexyl acrylate.

20. The method of claim 17, wherein the refractive index increasing monomer comprises ethoxylated o-phenyl phenol acrylate.
